(19) United States
(12) Patent Application Publication
(10) Pub. No.: US 2015/0181633 A1
(43) Pub. Date: Jun. 25, 2015

(54) METHOD FOR SETTING LINK FOR WI-FI DIRECT COMMUNICATION AND DEVICE FOR SAME

(71) Applicant: LG ELECTRONICS INC., Seoul (KR)

(72) Inventors: Suhwook Kim, Anyang-si (KR); Jinsam Kwak, Anyang-si (KR); Jinho Kim, Anyang-si (KR)

(73) Assignee: LG ELECTRONICS INC., Seoul (KR)

(21) Appl. No.: 14/421,761

(22) PCT Filed: Aug. 14, 2013
(86) PCT No.: PCT/KR2013/007328

§ 371 Date: Feb. 13, 2015

Related U.S. Application Data
(60) Provisional application No. 61/682,788, filed on Aug. 14, 2012.
(60) Provisional application No. 61/857,683, filed on Jul. 23, 2013.

(51) Int. Cl. H04W 76/02; H04W 8/00

(52) U.S. Cl. CPC H04W 76/023; H04W 8/005

(57) ABSTRACT

The present invention relates to a wireless communication system. Specifically, the present invention relates to a method for setting a link for Wi-Fi Direct P2P communication and a device for the same, the method comprising the steps of: discovering, by a STA, whether a joinable WFD communication group exists; and setting, by the STA which discovered a new WFD target, a link for joining into a joinable WFD group if the joinable WFD group exists.

### TECHNICAL FIELD

The present invention relates to a wireless communication system. In particular, the present invention relates to a method of performing WFD P2P communication and an apparatus therefor. In more particular, the present invention relates to a method of setting a link for WFD P2P communication and an apparatus therefor.

### BACKGROUND ART

A wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may include one of CDMA (code division multiple access) system, FDMA (frequency division multiple access) system, TDMA (time division multiple access) system, OFDMA (orthogonal frequency division multiple access) system, SC-FDMA (single carrier frequency division multiple access) system and the like.

A standard for a WLAN (wireless local area network) technology is developing by IEEE (Institute of Electrical and Electronics Engineers) 802.11 group. IEEE 802.11a and b use an unlicensed band on 2.4 GHz or 5 GHz. IEEE 802.11b provides transmission speed of 11 Mbps and IEEE 802.11a provides transmission speed of 54 Mbps. IEEE 802.11g provides transmission speed of 54 Mbps by applying OFDM (orthogonal frequency division multiplexing) on 2.4 GHz. IEEE 802.11n provides transmission speed of 300 Mbps by applying MIMO-OFDM (multiple input multiple output-OFDM). IEEE 802.11n supports channel bandwidth up to 40 MHz. In this case, IEEE 802.11n provides transmission speed of 600 Mbps. IEEE 802.11p corresponds to a standard used for supporting WAVE (wireless access in vehicular environments). For instance, 802.11p provides improvements necessary for supporting ITS (intelligent transportation systems). IEEE 802.11ai corresponds to a standard used for supporting fast initial link setup of IEEE 802.11 station (STA).

A DLS (direct link setup)-related protocol in wireless LAN environment according to IEEE 802.11e is on the premise of a QBSS (Quality BSS) that a BSS (basic service set) supports QoS (Quality of service). In the QBSS, not only a non-AP STA but also an AP corresponds to a QAP (Quality AP) supporting QoS. Yet, according to a currently commercialized wireless LAN environment (e.g., wireless LAN environment according to IEEE 802.11a/b/g), although a non-AP STA corresponds to a QSTA (Quality STA) capable of supporting QoS, most of APs correspond to a legacy AP incapable of supporting QoS. As a result, there is a limit even for a QSTA to use a DLS service in the currently commercialized wireless LAN environment.

A TDLS (tunneled direct link setup) is a wireless communication protocol newly proposed to overcome the aforementioned limitation. Although the TDLS does not support QoS, the TDLS enables QSTAs to set a direct link in such a currently commercialized wireless LAN environment as IEEE 802.11a, b, g and the like and the TDLS enables a direct link to be set even in a power save mode (PSM). Hence, the TDLS regulates all procedures to enable QSTAs to set a direct link even in a BSS managed by a legacy AP. In the following, a wireless network supporting the TDLS is called a TDLS wireless network.

First of all, it is necessary to concretely regulate a procedure of setting a direct link between two non-AP QSTAs in the TDLS wireless network. This is because, unlike a wireless network in IEEE 802.11e environment, an AP not supporting QoS is unable to directly engage in a procedure of setting a direct link between the non-AP QSTAs in the TDLS wireless network. In particular, in order to set a direct link, a message should be exchanged between the non-AP QSTAs and it is necessary to have detail information on a peer non-AP QSTA (e.g., MAC (medium access control) address and the like of the peer non-AP QSTA). Yet, a DLS link setup procedure regulated by IEEE 802.11e or a currently proposed TDLS link setup procedure has not concretely regulated the aforementioned necessity yet.

### DISCLOSURE OF THE INVENTION

### Technical Tasks

One object of the present invention is to provide a method of efficiently performing WFD (wireless fidelity direct) P2P (peer to peer) communication in a wireless communication system and an apparatus therefor. Another object of the present invention is to provide a method of efficiently setting a link for the WFD P2P communication and an apparatus therefor.

The other object of the present invention is to provide a method of efficiently setting a link for WFD P2P communication using a TDLS (tunneled direct link setup) scheme and an apparatus therefor.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a method of setting a new WFD link, which is set by a first station (STA), with a second STA performing WFD (wireless fidelity direct) communication includes the steps of transmitting link setup request information, which is transmitted by the first STA, to the second STA via a third STA, receiving response (setup response) information, which is received by the first STA, from the second STA in response to the link setup request information of the first STA transmitted via the third STA and transmitting link setup confirmation information, which is configured based on the response information received by the first STA in response to the link setup request information, to the second STA via the third STA. The third STA corresponds to a group owner (GO) of the WFD communication of the second STA.

In this case, the method can further include the steps of transmitting STA discovery request information, which is transmitted by the first STA, to the second STA via an AP of the first STA and receiving response (discovery response) information, which is received by the first STA, from the second STA in response to the transmitted STA discovery request information.

The STA discovery request information may correspond to information transmitted by the AP using one of a unicast method and a broadcast method.

The response (discovery response) information for the discovery request information can include information on whether the second STA operates as either a group owner or a group client (GC).

If the first STA is performing separate WFD communication with the second STA, the first STA can terminate the separate WFD communication before making a request for WFD communication link setup set with the second STA.

The link setup request information may include at least one of information indicating whether the first STA operates as a GO or a group client (GC) in a legacy WFD communication and a GO intent indicating whether the first STA intends to operate as a GO or a GC in a new WFD communication.

The response (setup response) information received from the second STA in response to the link setup request can include a GO intent value indicating whether the second STA intends to operate as either a GO or a group client (GC) in a new WFD communication.

An STA of which the GO intent value is higher can be determined as a GO in the new WFD communication.

The link setup confirmation information can include information on whether the first STA and the second STA correspond to a GO or a GC in a new WFD communication based on the response information received from the second STA in response to the link setup request information.

The link setup confirmation information can include information on a channel on which the WFD communication is to be performed between the first STA and the second STA.

An AP of the first STA may correspond to the third STA corresponding to a GO of the WFD communication of the second STA.

To further achieve these and other advantages and in accordance with the purpose of the present invention, as embodied and broadly described, according to a different embodiment, a method of setting a new WFD link between a first station (STA) performing WFD (wireless fidelity direct) communication and a second STA includes the steps of transmitting link setup request information, which is transmitted by the first STA, to the second STA via a third STA, receiving response (setup response) information, which is received by the first STA, from the second STA in response to the link setup request information of the first STA transmitted via the third STA and transmitting link setup confirmation information, which is generated based on the response information received by the first STA in response to the link setup request information, to the second STA via the third STA. The third STA corresponds to a group owner (GO) of the WFD communication of the first STA.

To further achieve these and other advantages and in accordance with the purpose of the present invention, as embodied and broadly described, according to a different embodiment, a link setup station including a first STA setting a new WFD link with a second station (STA) performing WFD (wireless fidelity direct) communication includes an RF (radio frequency) unit configured to communicate with a different terminal, a memory configured to store information transceived with the different terminal and a processor, the processor configured to control the first STA to transmit link setup request information to the second STA via a third STA, the processor configured to control the first STA to receive response (setup response) information from the second STA in response to the link setup request information via the third STA, the processor configured to control the first STA to transmit link setup confirmation information, which is configured based on the response information received in response to the link setup request information, to the second STA via the third STA. The third STA corresponds to a group owner (GO) of a WFD communication group of the first STA.

In this case, in case that the first STA performs an operation of discovering the second STA, the first STA can transmit STA discovery request information to the second STA via an AP of the first STA and receive response (discovery response) information from the second STA in response to the transmitted STA discovery request information.

### Advantageous Effects

According to the present invention, it is able to efficiently perform WFD P2P communication in a wireless communication system. Specifically, it is able to efficiently perform a link setup for the WFD P2P communication.

According to the present invention, it is able to reduce communication overhead of an STA generated in the step of discovering with each other between STAs intending to perform WFD communication and the step of performing a link setup.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1a and FIG. 1b are diagrams for an example of a structure of IEEE 802.11 system to which the present invention is applicable;

FIG. 2 is a diagram for an example of a WFD (Wi-Fi Direct) network;

FIG. 3 is a flowchart for a procedure of configuring a WFD network;

FIGS. 4 to 5 are diagrams for an example of a procedure of discovering a neighbor;

FIG. 6a and FIG. 6b are diagrams for a method of setting a link for new WFD communication to an STA performing legacy WFD communication as a legacy technology;

FIG. 7a and FIG. 7b are diagrams indicating that an STA performing WFD communication is associated with a communication group performing WFD as a legacy technology;

FIG. 8a and FIG. 8b are diagrams for a method of setting a link for new WFD communication to an STA performing legacy WFD communication as a legacy technology;

FIG. 9a and FIG. 9b are diagrams for a method of setting a link to enable an STA performing WFD communication to associate with a WFD communication group as a legacy technology;

FIG. 10 is a diagram for explaining a basic concept of TDLS (tunneled direct link setup);

FIG. 11 is a diagram for an example of a procedure of discovering a WFD target neighbor in TDLS;

FIG. 12 is a flowchart for a procedure of discovering an STA in TDLS;

FIG. 13 is a diagram for an example of a link setup using TDLS;

FIG. 14 is a diagram for explaining a basic concept of TDLS in relation to WFD to set a WFD link using TDLS according to the present invention;

FIG. 15 is a flowchart for a link setup using TDLS for WFD according to the present invention;

FIG. 16a and FIG. 16b are diagrams for one embodiment of a method of setting a link using TDLS for new WFD communication according to the present invention;

FIG. 17a and FIG. 17b are diagrams for a different embodiment of a method of setting a link using TDLS for new WFD communication according to the present invention;

FIG. 18a and FIG. 18b are diagrams for a further different embodiment of a method of setting a link using TDLS for new WFD communication according to the present invention;

FIG. 19a and FIG. 19b are diagrams for a further different embodiment of a method of setting a link using TDLS for new WFD communication according to the present invention;

FIG. 20 is a diagram for an example of a WFD P2P device to which the present invention is applicable.

### BEST MODE

### Mode for Invention

The following description of embodiments of the present invention may apply to various wireless access systems including CDMA (code division multiple access), FDMA (frequency division multiple access), TDMA (time division multiple access), OFDMA (orthogonal frequency division multiple access), SC-FDMA (single carrier frequency division multiple access), OFDM (orthogonal frequency division multiplexing) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.16 (WiMAX), IEEE 802.20, E-UTRA (Evolved UTRA), etc. OFDM can be implemented with such a radio technology as IEEE 802.11 and the like.

For clarity, the following description mainly concerns IEEE 802.11 (Wi-Fi), by which the technical idea of the present invention may be non-limited. For instance, following description may be supported by the disclosed standard documents of at least one of wireless access systems including IEEE 802 system, 3GPP system, 3GPP LTE and LTE-A (LTE-Advanced) system and 3GPP2 system. In particular, the steps or parts, which are not explained to clearly reveal the technical idea of the present invention, in the embodiments of the present invention may be supported by the above documents. Moreover, all terminologies disclosed in this document may be supported by the above standard documents.

Specific terminologies used for the following description may be provided to help the understanding of the present invention. And, the use of the specific terminology may be modified into other forms within the scope of the technical idea of the present invention. Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts. A sequence of operations explained for each embodiment of the present invention may be modified. Some configurations or features of one embodiment may be included in another embodiment or can be substituted for corresponding configurations or features of another embodiment.

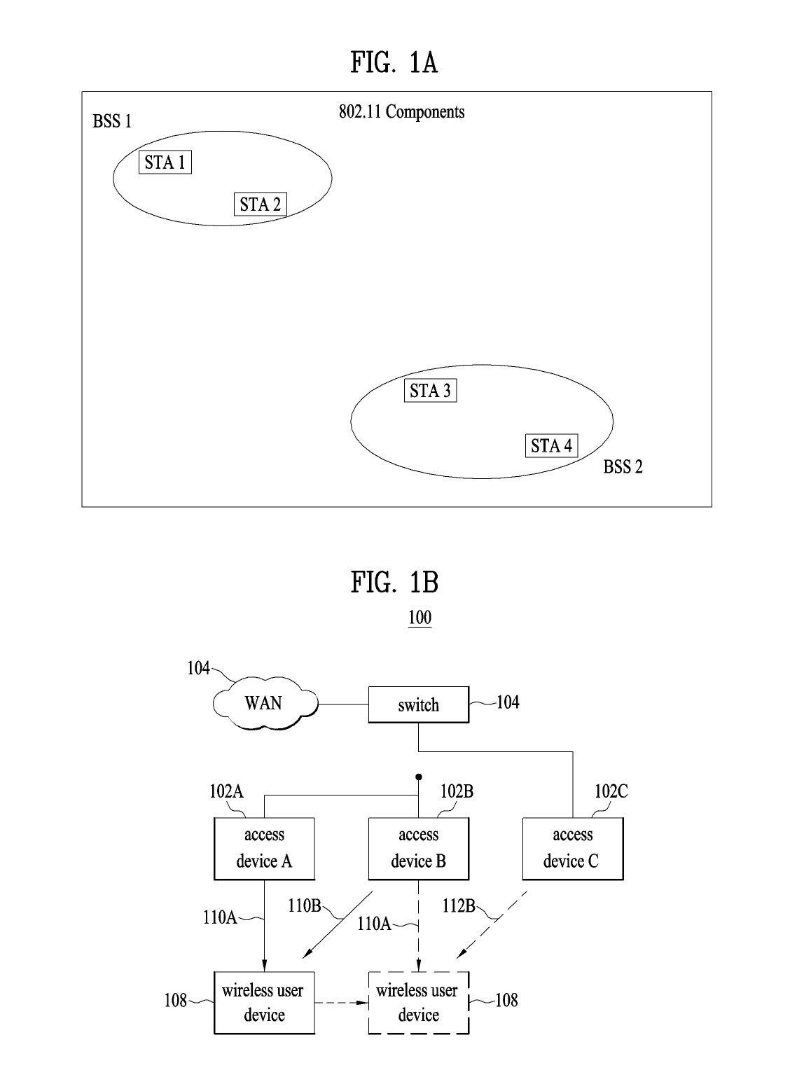

FIG. 1a is a diagram for an example of a structure of IEEE 802.11 system to which the present invention is applicable.

IEEE 802.11 structure can consist of a plurality of configuration elements and a WLAN supporting mobility of an STA, which is transparent to an upper layer, can be provided by interaction of a plurality of the configuration elements. A basic service set (hereinafter abbreviated BSS) may correspond to a basic configuration block of IEEE 802.11 LAN. FIG. 1 shows an example that there exist two BSSs (BSS 1 and BSS 2) and two STAs are included in each of the BSSs as members, respectively (STA 1 and STA 2 are included in the BSS 1 and STA 3 and STA 4 are included in the BSS 2). In this case, an STA may correspond to a device operating according to MAC (medium access control)/PHY (physical) regulation of IEEE 802.11. An STA includes an AP (access point) STA (simply, an AP) and a non-AP STA. An AP corresponds to a device providing network (e.g., WLAN) access to the non-AP STA via a wireless interface. The AP can be configured by a stationary type or a mobile type and includes a portable wireless device (e.g., a laptop computer, a smartphone and the like) providing a hot-spot. The AP corresponds to a base station (BS), a Node-B, an evolved Node-B (eNB), a base transceiver system (BTS), a femto base station (a femto BS) or the like in a different wireless communication field. In general, the non-AP STA corresponds to a device directly handled by a user such as a laptop computer, a PDA, a wireless modem, a smartphone. The non-AP STA can be called a terminal, a wireless transmit/receive unit (WTRU), a user equipment (UE), a mobile station (MS), a mobile terminal, a mobile subscriber station (MSS) or the like.

In FIG. 1a, an oval indicating a BSS may be comprehended as a coverage area of STAs included in the BSS maintaining communication. This area can be called a basic service area (BSA). A BSS of a most basic type in IEEE 802.11 LAN may correspond to an independent BSS (IBSS). For instance, the IBSS may have a minimum form consisting of two STAs only. The BSS (BSS 1 or BSS 2), which is the simplest form and different configuration elements are omitted, in FIG. 1 may correspond to a representative example of the IBSS. This sort of configuration is available only when the STAs are able to directly communicate with each other. And, this type of LAN can be configured when a LAN is required instead of being planned and configured in advance. Hence, this type of LAN can be called an ad-hoc network.

When power of an STA is turned on or turned off or an STA enters into a BSS area or gets out of the BSS area, membership of the STA can be dynamically changed in the BSS. In order to become a member of the BSS, the STA can join the BSS using a synchronization process. In order to access all services of a BSS-based structure, the STA can be associated with the BSS.

FIG. 1b is a diagram for an example of a communication system 100 adopting access devices (e.g., AP STAs) 102A/102B/102C and wireless user devices (e.g., non-AP STAs).

Referring to FIG. 1b, the access devices 102A/102B/102C are connected to a switch 104 providing access to such a wide area network (WLAN) 106 as the Internet. Each of the access devices 102A/102B/102C provides radio access to wireless devices belonging to a coverage area (not depicted) of the access device via a time division multiplexed network. Hence, the access devices 102A/102B/102C commonly provide total WLAN coverage area of the system 100. For instance, a wireless device 108 may exist in a coverage area of the access devices (102A and 102B) at a position indicated by a box represented by a line. Hence, the wireless device 108 can receive beacons represented by a line arrow (110A and 110B) from each of the access devices (102A and 102B). If the wireless device 108 roams from the position of a line box to a position of a dotted line box, the wireless device 108 enters into a coverage area of the access device 102C and is getting out of the coverage area of the access device 102A. Hence, the wireless device 108 can receive beacons represented by a dotted line arrow (112A and 112B) from the access devices (102B and 102C).

When the wireless device 108 roams in the total WLAN coverage area provided by the system 100, the wireless device 108 can determine an access device currently providing best access to the wireless device 108. For instance, the wireless device 108 repeatedly scans beacons of neighboring access devices and can measure signal strength (e.g., power) related to each of the beacons. By doing so, the wireless device 108 is able to connect with an access device providing optimal network access based on maximum beacon signal strength. The wireless device 108 may use a different criterion related to optimal access. For instance, the optimal access may be associated with more number of preferred services (e.g., contents, data rate and the like).

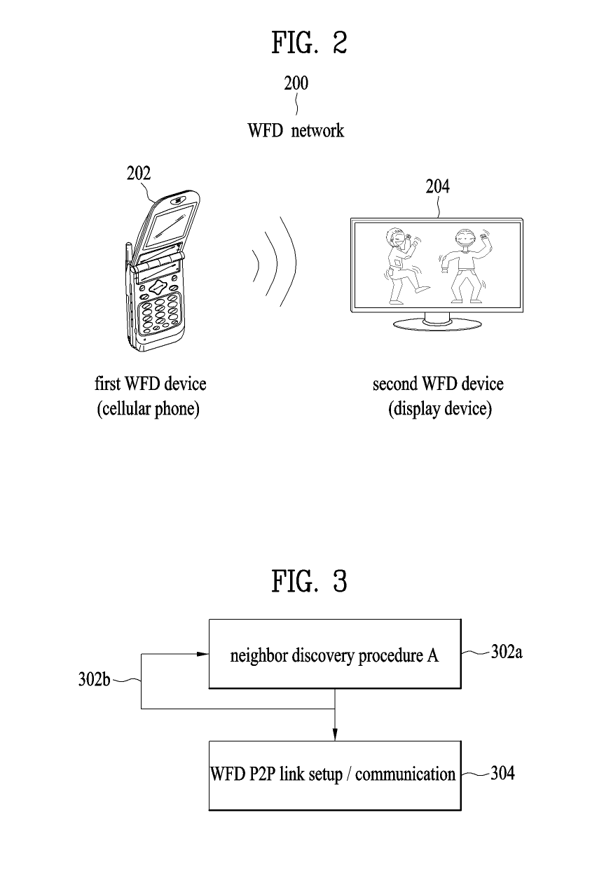

FIG. 2 is a diagram for an example of a WFD (Wi-Fi Direct) network. The WFD network corresponds to a network capable of performing device-to-device (D2D) (or peer to peer (P2P) communication although Wi-Fi devices do not join a home network, an office network and a hot spot network. The WFD network is proposed by Wi-Fi alliance. In the following, communication performed based on WFD is called WFD D2D communication (simply, D2D communication) or WFD P2P communication (simply, P2P communication). And, a device performing WFD P2P is called a WFD P2P device, simply, a P2P device in the following.

Referring to FIG. 2, a WFD network 200 can include at least one or more Wi-Fi devices including a first WFD device 202 and a second WFD device 204. A WFD device includes devices supporting a display device, a printer, a digital camera, a projector, a smartphone and the like. And, the WFD device includes a non-AP STA and an AP STA. In an example shown in the drawing, the first WFD device 202 corresponds to a smartphone and the second WFD device 204 corresponds to a display device. The WFD devices belonging to the WFD network can be connected with each other. Specifically, P2P communication may correspond to a case that a signal transmission path between two WFD devices is directly configured between the two WFD devices without passing through a third device (e.g., an AP) or a legacy network (e.g., accessing WLAN via an AP). In this case, the signal transmission path directly configured between the two WFD devices may be restricted to a data transmission path. For instance, the P2P communication may correspond to a case that a plurality of non-STAs transmit data (e.g., audio/image text message information etc.) without passing through an AP. A signal transmission path used for transmitting control information (e.g., resource allocation information for P2P configuration, wireless device identification information etc.) can be directly configured between WFD devices (e.g., between non-AP STAs or between a non-AP STA and an AP). Or, the signal transmission path for the control information can be configured between two WFD devices (e.g., between non-AP STAs) via an AP or between an AP and a corresponding WFD device (e.g., between AP and non-AP STA #1 or between AP and non-AP STA #2).

FIG. 3 is a flowchart for a procedure of configuring a WFD network.

Referring to FIG. 3, a procedure of configuring a WFD network can be classified into two procedures. One is a neighbor discovery (ND) procedure [S302a] and another is a P2P link setup and communication procedure [S304]. Via the neighbor discovery procedure, a WFD device (e.g., 202 in FIG. 2) discovers a different neighboring WFD device (e.g., 204 in FIG. 2) in (wireless) coverage (of the WFD device) and can obtain information required to be associated with (e.g., pre-association) the neighboring WFD device. In this case, the pre-association may correspond to a second layer pre-association in a wireless protocol. For instance, the information necessary for the pre-association may include identification information on the neighboring WFD device and the like. The neighbor discovery procedure can be performed according to an available radio channel [S302b]. Subsequently, the WFD device 202 can perform a procedure for the WFD P2P link setup/communication together with the different WFD device 204. For instance, after the WFD device 202 is connected with the neighboring WFD device 204, the WFD device 202 can determine whether the neighboring WFD device 204 satisfies a service requirement of a user. To this end, the WFD device 202 is second layer pre-associated with the neighboring WFD device 204 and may be then able to search for the neighboring WFD device 204. If the neighboring WFD device 204 does not satisfy the service requirement of the user, the WFD device 202 disconnects the second layer association associated with the WFD device 204 and may configure the second layer association with a different WFD device. On the contrary, if the corresponding WFD device 204 satisfies the service requirement of the user, the two WFD devices 202/204 can transmit a signal via a P2P link.

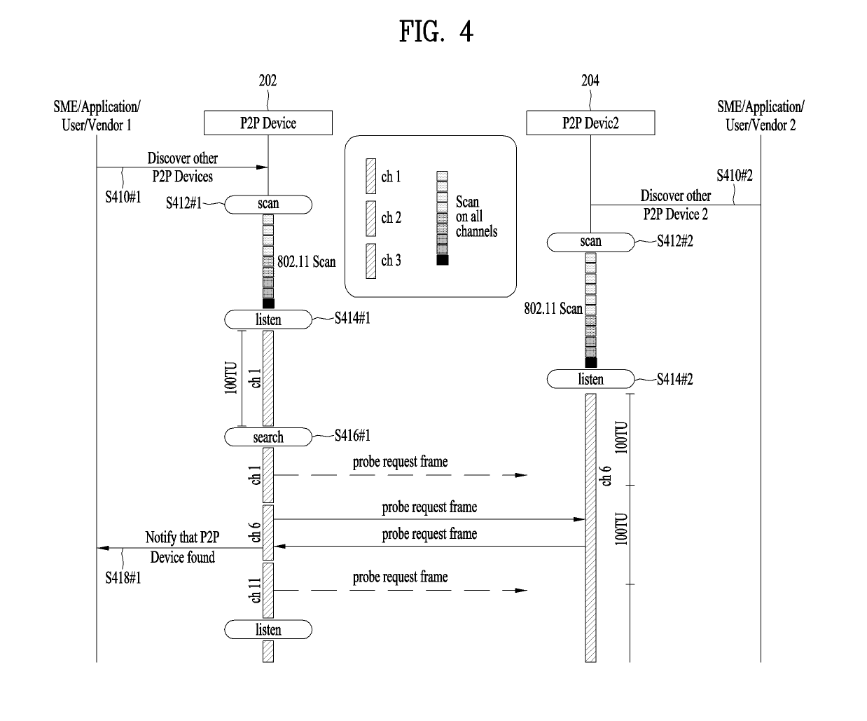

The neighbor discovery procedure is shown in FIG. 4 in more detail. The present example shows an example of operations between the WFD device 202 and the WFD device 204 mentioned earlier in FIG. 3.

Referring to FIG. 4, the neighbor discovery procedure of FIG. 3 can be initiated by an indication of an SME (station management entity), an application, a user or a vendor [S410] and the neighbor discovery procedure can be divided into a scan phase [S412] and a find phase [S414 to S416]. The scan phase [S412] includes an operation of scanning all available radio channels according to 802.11 scheme. By doing so, a P2P device can check a best operation channel. The find phase [S414 to S416] include a listen mode [S414] and a search mode [S416] and the P2P device alternately repeats the listen mode [S414] and the search mode [S416]. The P2P devices 202/204 perform an active search using a probe request frame in the search mode [S416] and may restrict a search range to a social channel including a channel 1, 6 and 11 (2412, 2437 and 2462 MHz) for a fast search. And, the P2P devices 202/204 maintain a state of the P2P devices as a receiving state in a manner of selecting a single channel from the three social channels in the listen mode [S414]. In this case, if a probe request frame, which is transmitted by a different P2P device (e.g., 202) in the search mode, is received, the P2P device (e.g., 204) transmits a probe response frame in response to the probe request frame. Duration of the listen mode [S414] can be randomly given (e.g., 100, 200, 300 TU (time unit)). The P2P devices continuously repeat the search mode and the receiving mode and may be able to arrive at a common channel common to the P2P devices. After the P2P devices discovers a different P2P device, the P2P devices can discover and exchange a device type, a name of a manufacturer or a familiar device name with each other using a probe request frame and a probe response frame to selectively combine with the discovered P2P device. If a neighboring P2P device is discovered and required information is obtained via the neighbor discovery procedure, the P2P device (e.g., 202) can inform the SME, the application, the user or the vendor of the discovered neighboring P2P device [S418].

Currently, P2P is mainly used for semi-static communication such as remote printing, picture sharing and the like. Yet, as a Wi-Fi device is generalized and location-based services are disseminated, usability of the P2P is widening more and more. For instance, it is expected that the P2P is actively used for social chatting (e.g., wireless devices enrolled in an SNS (social network service) recognize a wireless device located at a near region based on a location-based service and transmit/receive information), providing a location-based advertising, broadcasting location-based news, interworking a game between wireless devices and the like. For clarity, this sort of P2P application is called a new P2P application in the following.

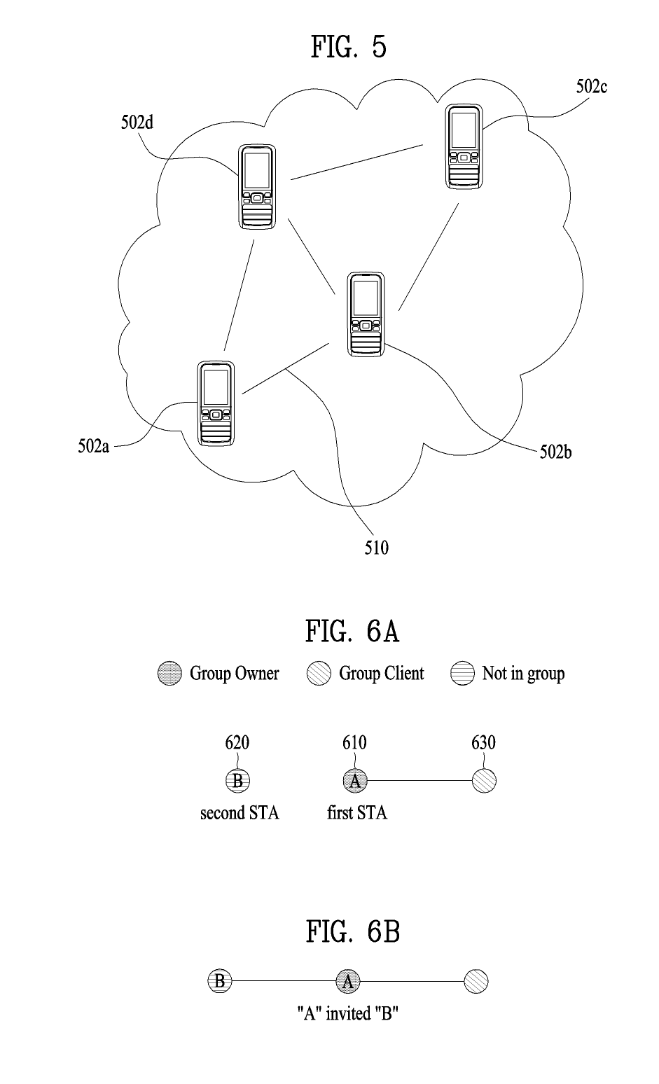

FIG. 5 shows an example of an aspect of a WFD network in case of applying a new P2P application (e.g., social chatting, providing a location-based service, interworking a game and the like).

Referring to FIG. 5, a plurality of P2P devices 502a to 502d perform P2P communication 510 in a WFD network. P2P device(s) included in the WFD network frequently changes due to movement of the P2P device and the WFD network itself may be newly generated or disappeared dynamically/temporarily. Hence, characteristics of the new P2P application is that P2P communication can be dynamically/temporarily performed between considerable numbers of P2P devices in a dense network environment.

Yet, since a legacy P2P mechanism does not consider dynamic P2P communication between pluralities of P2P devices, it is difficult for the legacy P2P mechanism to efficiently cope with the new P2P application. As an example, the legacy neighbor discovery procedure mentioned earlier with reference to FIG. 3 to FIG. 4 is not appropriated for the aforementioned new P2P application. As mentioned earlier with reference to FIG. 4, the neighbor discovery procedure consists of a search mode and a listen mode. The search mode and the listen mode are independently configured according to a P2P device and information on the configuration is not shared between P2P devices. Hence, in order to perform P2P communication, the P2P devices repeat the search mode and the listen mode using an on-demand/blind scheme and arrive at a channel common to the P2P devices. If the number of P2P devices participating in a WFD network is less, the neighbor discovery procedure of the blind scheme may enhance a resource efficiency by reducing unnecessary signaling overhead. Yet, when the number of P2P devices participating in the WFD network increases to a considerable level, if P2P communication is performed according to the legacy scheme, it may cause (1) great amount of latency time taken until neighbor discovery is completed, (2) inefficient neighbor discovery in a dense network (great amount of overhead), (3) great amount of communication overhead necessary for establishing connection and the like.

FIG. 6a and FIG. 6b are diagrams for a method of setting a link for new WFD communication to an STA performing legacy WFD communication as a legacy technology.

As shown in FIG. 6a, a first STA 610 (hereinafter called A) is operating in legacy WFD communication as a group owner. When the A communicates with a group client 630 of the legacy WFD communication, if the A 610 discovers a second STA 620 (hereinafter called B), which is a new WFD communication target and is not performing WFD communication, the A 610 attempts to establish a link with the B 620. In this case, new WFD communication corresponds to WFD communication between the A 610 and the B 620. Since the A corresponds to the group owner, the A can perform communication configuration irrespective of the communication with the legacy group client 630. Since one WFD group consists of one group owner and one or more group clients, it satisfies the A 610, which is one group owner. Hence, as shown in FIG. 6b, a WFD link can be established. In this case, the A 610 invites the B 620 to the legacy WFD communication group. Due to the characteristic of the WFD communication, WFD communication between the A 610 and the B 620 and WFD communication between the A 610 and the legacy group client 630 are available. Yet, WFD communication between the B 620 and the legacy group client 630 is not supported. This is because both the B and the group client are the group client.

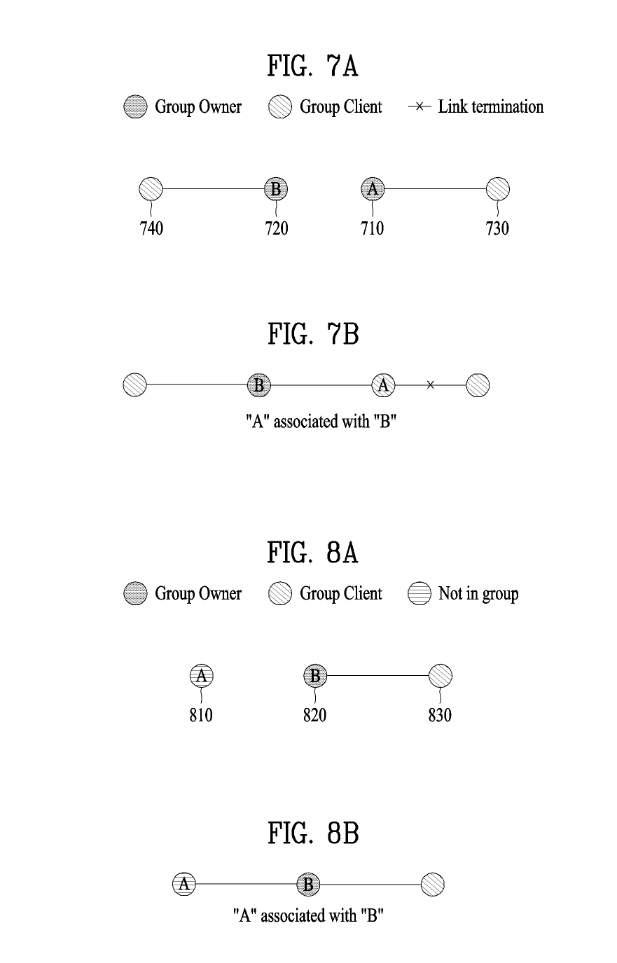

FIG. 7a and FIG. 7b are diagrams indicating that an STA performing WFD communication is associated with a communication group performing WFD as a legacy technology.

As shown in FIG. 7a, a first STA 710 (hereinafter called A) is communicating with a group client 720 as a group owner and a second STA 720 (hereinafter called B) is communicating with a group client 740 as a group owner. As shown in FIG. 7b, the A 710 terminates legacy communication and may be able to associate with a WFD communication group to which the B 720 belongs thereto. Since the B 720 corresponds to the group owner, the A 710 becomes a group client of the B. It is preferable to terminate the legacy WFD communication before the A 710 asks the B 720 to connect with the A.

FIG. 8a and FIG. 8b are diagrams for a method of setting a link for new WFD communication to an STA performing legacy WFD communication as a legacy technology.

As shown in FIG. 8a, a second STA 820 (hereinafter called B) is operating as a group owner in legacy WFD communication. When the B performs WFD communication with a group client 830 in the legacy WFD communication, a first STA 810 (hereinafter called A), which has discovered the B 820 and is not performing the WFD communication, attempts to establish a link with the B 820 for new WFD communication. In this case, if the B 820 accepts the link setup, a new WFD communication link is setup between the A 810 and the B 820 and the A 810 operates as a client of the legacy WFD group of the B 820. In this case, the A 810 associates with the WFD communication group of the B 820. The A 810 can perform WFD communication with the B 820 only which is the group owner and WFD communication between the A 810 and the client 830 of the legacy WFD communication is not supported. This is because both the A and the client correspond to the group client.

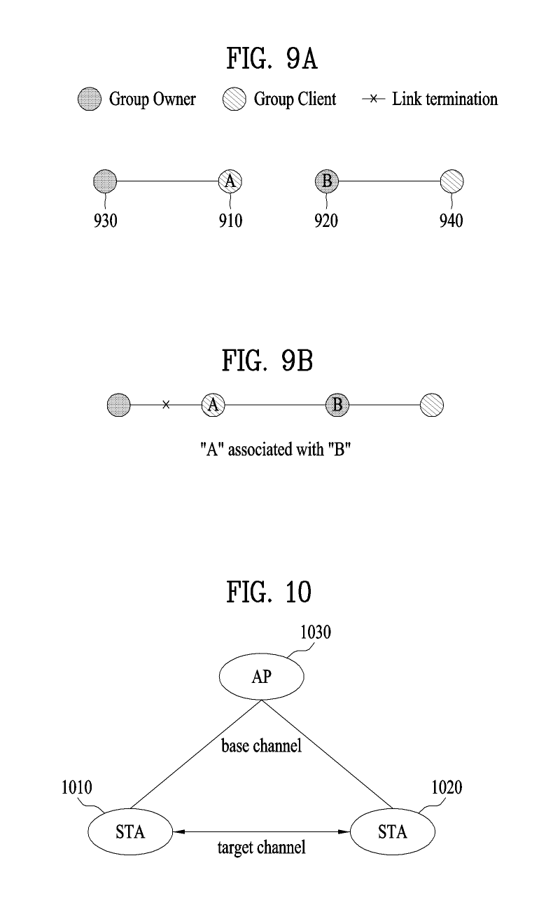

FIG. 9a and FIG. 9b are diagrams for a method of setting a link to enable an STA performing WFD communication to associate with a WFD communication group as a legacy technology.

As shown in FIG. 9a, a first STA 910 (hereinafter called A) performs WFD communication with a group owner 930 as a group client. In this case, if the A 910 discovers a second STA 920 (hereinafter called B), which is communicating with a group client 940 of a different WFD communication as a group owner, the A 910 terminates a link with the group owner 930 and can associate with WFD of the B 920.

As mentioned earlier with reference to FIG. 6 to FIG. 9, when a communication link is established, if an STA becomes a group owner (GO) and invites a new STA to a group of the STA or if an STA associates with a WFD group of a group owner (GO), considerable amount of communication overhead may occur in a procedure of discovering with each other between an STA (first STA) requesting a new WFD communication link and an STA (second STA) receiving the request and a procedure of directly discovering a different terminal in a step of establishing a communication link. Moreover, after the discovery procedure, communication overhead may occur in a procedure of matching a channel with each other. The first STA and the second STA continuously repeat a procedure of transmitting and receiving a discovery request and a discovery request response in the procedure of discovering with each other and may be able to complete the discovering procedure when the first STA and the second STA confirm that the first STA and the second STA arrive at a channel common to the first STA and the second STA. If there exist less number of WFD devices in a prescribed area and the aforementioned repetitive procedure is performed by less count, the aforementioned procedure may be efficient. Yet, if the aforementioned repetitive procedure is performed between WFD devices in a dense network to find out a common channel, communication overhead may occur.

FIG. 10 is a diagram for explaining a basic concept of TDLS (tunneled direct link setup).

As shown in FIG. 10, an AP can provide a service to a plurality of stations (STAs) in a wireless LAN system. FIG. 10 shows an example of a form that two STAs (first STA 1010 and second STA 1020) belong to a single AP 1030.

TDLS corresponds to channel configuration configured by the first STA 1010 to directly perform communication with the second STA 1020 without involvement of the AP. According to the TDLS, a link between the STAs can be directly configured without involvement of the AP in a manner that configuration messages for the TDLS are included (encapsulated) in a data frame. It is not required for the AP to have capability of configuring a direct link and capability used for a direct link between the two STAs performing the TDLS.

For the TDLS, one STA (e.g., first STA 1010)) transmits a TDLS request message on a base channel and another STA (e.g., second STA 1020)) transmits a TDLS response message on the base channel. By doing so, TDLS supporting capability and the like of the two STAs can be checked. In the example mentioned above, the first STA 1010 can complete the TDLS by transmitting a TDLS confirmation message.

After the TDLS is completed, one STA (e.g., first STA 1010) can transmit a request message requesting switch to a target channel and may perform TDLS-based direct communication on the target channel in a manner of receiving a response message in response to the channel switching request message.

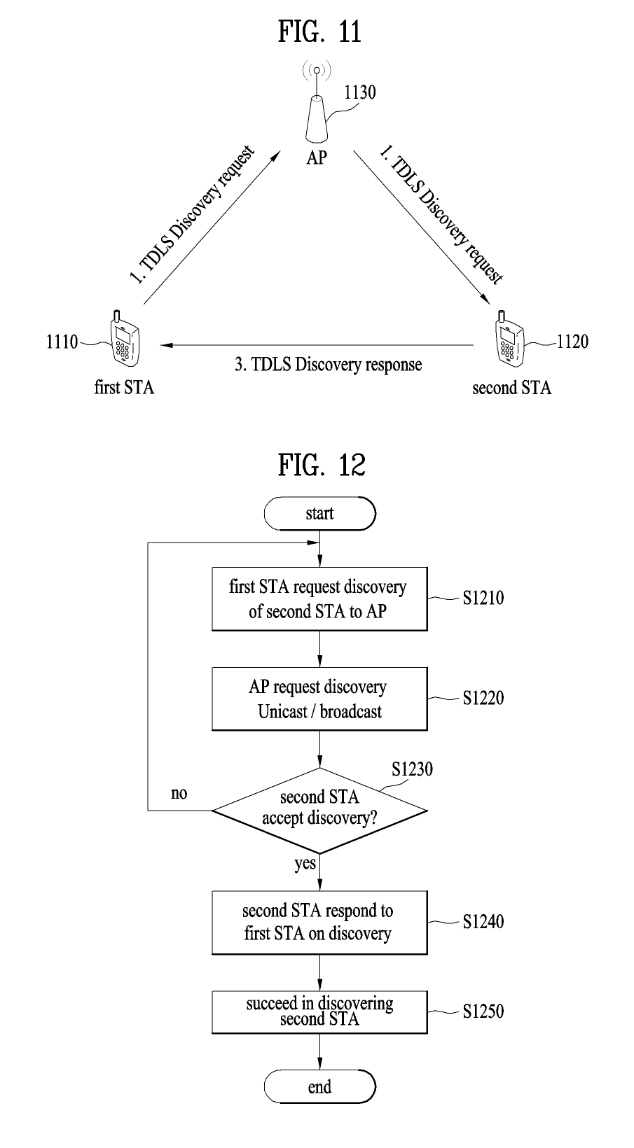

FIG. 11 is a diagram for an example of a procedure of discovering a WFD target neighbor in TDLS.

TDLS (tunneled direct link setup) is mainly classified into a two steps. A first step is to discover a neighboring STA with which an STA is to communicate and a second step is to set a link to the discovered neighboring STA. FIG. 11 explains a procedure of discovering the neighboring STA.

Referring to FIG. 11, a first STA 1110 intending to discover a neighboring STA transmits TDLS discovery request information to an AP 1130. In this case, the AP 1130 corresponds to an AP for the first STA 1110. The AP 1130 transmits the TDLS discovery request information received from the first STA 1110 to STAs belonging to an area of the AP 1130. This transmission scheme can include a unicast or broadcast method. A second STA 1120 receives the information indicating that the first STA 1110 requests discovery of a neighboring STA from the first STA and may be then able to transmit second STA discovery response information to the first STA 1110. When the second STA 1120 transmits the discovery response information to the first STA 1110, the second STA 1120 can directly transmit the discovery response information to the first STA 1110 without passing through the AP 1130. If the second STA 1120 is located within a prescribed distance capable of communicating with the first STA 1110, the first STA 1110 receives the discovery response information of the second STA 1120 and may be then able to discover the second STA 1120.

FIG. 12 is a flowchart for a procedure of discovering an STA in TDLS.

In order for a first STA to discover a new target of communication, the first STA asks an AP of the first STA to discover the new target [S1210]. Having received discovery request information from the first STA, the AP broadcasts the information to STAs belonging to an area of the AP [S1220]. In this case, the broadcasting may include a unicast or a broadcast scheme. Among the STAs belonging to the area of the AP, a second STA receives the discovery request information of the first STA from the AP and determines whether to response in response to the discovery request information [S1230]. Or, all STAs, which have received the broadcasting from the AP, may mandatorily response in response to the discovery request information. If the second STA does not respond to the discovery, in other word, if the first STA receives no response information, the first STA may continuously transmit discovery request or terminate it. The second STA transmits discovery response information to the first STA in response to the discovery request information [S1240]. In this case, the second STA directly transmits the discovery response information to the first STA. If the first STA and the second STA are not located within a prescribed distance and the first STA is unable to receive the discovery response information of the second STA, the first STA may continuously transmit discovery request or terminate it. If the first STA receives the discovery response information of the second STA, the second STA discovery of the first STA is completed [S1250].

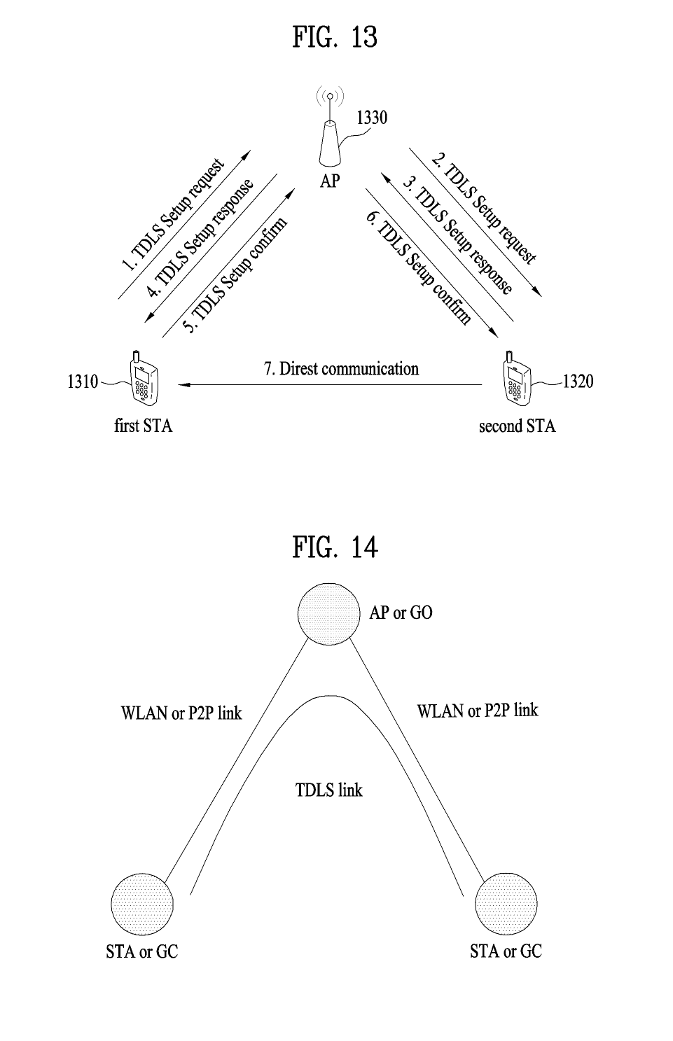

FIG. 13 is a diagram for an example of a link setup using TDLS.

Referring to FIG. 13, it explains a link setup method of a first STA 1310, which has discovered a second STA 1320, using a TDLS scheme. The first STA 1310 intending to establish a link with the second STA 1320 transmits TDLS setup request information to an AP 1330 without making a direct link setup request to the second STA 1320. The AP 1330 delivers the TDLS setup request information received from the first STA 1310 to the second STA 1320 as it is.

Having received the TDLS setup request information from the AP 1330, the second STA 1320 determines whether to accept a setup request.

The second STA 1320 transmits TDLS setup response information to the AP 1330 in response to the TDLS setup request of the first STA 1310. The second STA 1320 also transmit the TDLS setup response information to the first STA 1310 via the AP 1330 without directly transmitting the TDLS setup response information to the first STA. Having received the TDLS setup response information from the second STA 1320, the AP 1330 delivers the TDLS setup response information to the first STA 1310 as it is.

Information on whether the second STA 1320 accepts the setup request of the first STA 1310 can be included in the TDLS setup response information. Having received the TDLS setup response information of the second STA 1320 via the AP 1330, the first STA 1310, if the second STA does not accept link setup, may transmit link setup request information to a different discovered STA. If there is no discovered STA, the first STA may perform the neighboring STA discovery procedure again.

If the second STA 1320 accepts the link setup, the first STA 1310 transmits TDLS link setup confirmation information related to new WFD communication to the second STA 1320 via the AP 1330 using a scheme similar to the scheme previously used to transmit the TDLS setup request information. Having received the TDLS setup confirmation information from the first STA 1310, the AP delivers the TDLS setup confirmation information to the second STA 1320.

Finally, after link setup information is shared between the first STA 1310 and the second STA 1320, the first STA 1310 and the second STA 1320 can perform new communication according to the shared setup information.

Hence, the present invention proposes a method of more efficiently performing a WFD link setup using a TDLS scheme in case of setting a WFD link. In the following, as a technology applicable to the present invention, a method of setting a new WFD link, which is set in a manner of applying a TDLS link setup scheme to WFD link setup, and an apparatus therefor are explained.

FIG. 14 is a diagram for explaining a basic concept of TDLS in relation to WFD to set a WFD link using TDLS according to the present invention.

A group owner in WFD broadcasts neighbor list information to neighboring P2P devices (in an operation frequency) and can receive neighbor advertisement information from P2P devices intending to join a P2P group. In this case, for instance, the neighbor list information can include P2P device identification information (e.g., a device ID, a device nickname and the like), mobility-related information (e.g., moving speed), power information, P2P service-related information (e.g., a service type, a social group and the like), information for pre-association with a corresponding P2P device and the like. The neighbor list information can be broadcasted by a request of a neighboring P2P device or can be periodically broadcasted. The neighbor list information can be transmitted via a beacon. A group owner can be configured in advance (e.g., an AP), one of a plurality of P2P devices is selected as a group owner by a network according to a situation or one of a plurality of the P2P devices may autonomously operate as a group owner according to a situation. And, the number of P2P devices capable of being managed by a group owner can be restricted according to WFD capability, coverage, available power and the like. To this end, the neighbor list information can additionally include group available information (e.g., 1-bit information). For instance, the number of P2P devices capable of being managed by a group owner corresponds to N and N number of P2P devices join in a group, the group owner can set the group available information with a specific value (e.g., 1) not permitting group joining.

A P2P device may use the neighbor advertisement information to inform a group owner of group joining intention of the P2P device. And, the neighbor advertisement information can include such information necessary for a group owner 602d to generate and manage a neighbor list as P2P device identification information (e.g., a device ID, a device nickname and the like), mobility-related information (e.g., moving speed), power information, P2P service-related information (e.g., a service type, a social group and the like). Transmission of the neighbor advertisement information can be initiated when the neighbor list information is received. Or, transmission of the neighbor advertisement information can be initiated when P2P group joining is required irrespective of whether the neighbor list information is received.

Referring to FIG. 14, it is able to know that an AP STA in TDLS corresponds to a GO in WFD and a non-AP STA in TDLS corresponds to a group client (GC) in WFD. If communication between the AP STA and the non-AP STA in TDLS corresponds to WLAN communication, it may correspond to P2P (peer to peer) communication in WFD.

In WFD, a P2P group can consist of a single group owner and one or more group clients. A group client (or a group member) can communicate with a group owner. Yet, the group client does not support communication with a different group client. Similarly, the group owner does not support communication with a different group owner.

A group owner can be configured in advance (e.g., an AP), one of a plurality of P2P devices is selected as a group owner by a network according to a situation or one of a plurality of the P2P devices may autonomously operate as a group owner according to a situation. As a criterion of determining a group owner, a side where a group owner intent value is larger can be determined as the group owner. The group owner intent value can be determined by a value between 0 and 15. For instance, if the group owner intent value corresponds to 0, it may be determined as a terminal operating as a group client without an intention of being a group owner. If the group owner intent value corresponds to 15, it may be determined as a terminal operating as a group owner only.

In the following, a method for an STA performing legacy WFD communication to set a link for new WFD communication is explained via embodiments.

### Embodiment 1

### First STA Associates with Second STA Group Performing WFD Communication

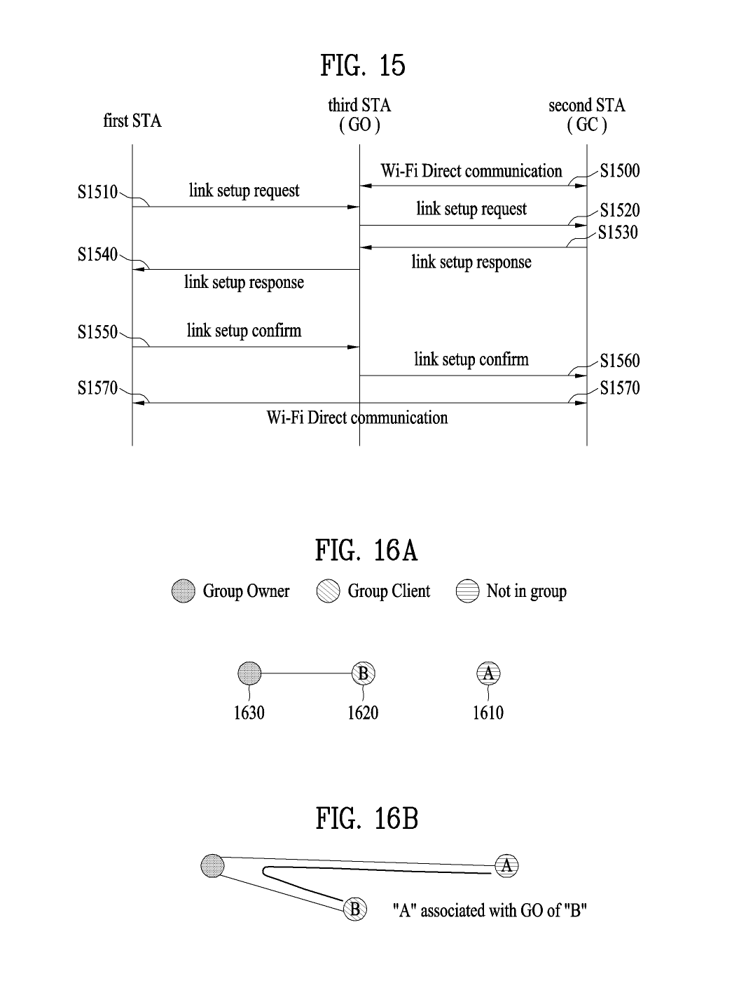

FIG. 15 is a flowchart for a link setup using TDLS for WFD according to the present invention.

A method for a first STA to set a new WFD link with a second STA performing WFD communication is explained with reference to FIG. 15. The second STA and a third STA are performing communication as a GC and a GO, respectively, of a WFD communication group [S1500]. The first STA can perform a step [S1520] of transmitting link setup request information to the second STA via the third STA [S1510]. In this case, the link setup request information can include information on whether the first STA operates as either a GO or a GC in legacy WFD communication and/or a GO intent value indicating whether the first STA intends to operate as either a GO or a GC in new WFD communication.

The first STA can perform a step [S1540] of receiving setup response information from the second STA in response to the link setup request information of the first STA transmitted via the third STA [S1530]. The setup response information of the second STA transmitted in response to the link setup request can include a GO intent value indicating whether the second STA intends to operate as either a GO or a GC in new WFD communication. A method of determining a group owner (GO) in new WFD communication using an intent value is explained in the following. An STA of a higher GO intent value may become a GO in the new WFD communication. When the first STA performs a step [S1560] of transmitting link setup confirmation information to the second STA via the third STA [S1550], a new WFD link setup is completed. In this case, the link setup confirmation information is configured based on the response information received in response to the transmitted link setup request information. Subsequently, one of the first STA and the second STA operates as a group owner (GO) and another operates as a group client (GC). The link setup confirmation information can include information on whether the second STA is determined as a GO or a GC in the new WFD communication based on the response information of the second STA which is received in response to the link setup request information. The link setup confirmation information can further include information on a channel on which WFD communication is performed between the first STA and the second STA. The AP, which is used to discover the second STA by the first STA, may correspond to the third STA corresponding to a GO of the second STA in WFD communication.

If the first STA is performing separate WFD communication with the second STA, the first STA terminates the separate WFD communication before making a request for WFD communication link setup with the second STA and may be then able to transmit setup request information to the second STA.

The first STA may be in a state of not performing communication, performing communication as a GO or performing communication as a GC. Each case is explained with reference to FIG. 16 in the following.

1-1 First STA is in a State of not Performing WFD Communication

FIG. 16a and FIG. 16b are diagrams for one embodiment of a method of setting a link using TDLS (tunneled direct link setup) for new WFD communication according to the present invention.

As shown in FIG. 16a, a first STA 1610 (hereinafter called A) performs no WFD communication. If the A discovers a new WFD connection target, i.e., a second STA 1620 (hereinafter called B) performing WFD communication, the A 1610 is unable to set a direct link to the B 1620. Since there exists only one group owner in a single communication group, the A 1610 may associate with a legacy WFD communication group of the B 1620 as a group client since there exists a group owner 1630 in the legacy WFD communication group.

As shown in FIG. 16a, when the B 1620 is operating as a client in the legacy WFD communication group, the TDLS link setup method mentioned earlier in FIG. 14 can be applied. After the A 1610 has discovered the B 1620, the WFD group owner 1630 of the B 1620 plays a role of an AP STA in TDLS link setup in a step of setting a link. In other word, if the A 1610 transmits TDLS link setup request information to the group owner 1630, the group owner 1630 delivers the TDLS link setup request information to the B 1620. In this case, the link setup request information can include information indicating that the A 1610 belongs to no WFD communication group. Having received the link setup request information, the B 1620 determines whether to accept link setup. Having accepted the link setup request, the B 1620 transmits link setup response information to the group owner 1630. The group owner 1630 delivers the received link setup response information to the A 1610. In this case, the link setup response information can include information on whether the B 1620 accepts WFD communication with the A 1610. If the B accepts the link setup for the WFD communication with the A 1610, the link setup response information can further include information indicating whether the B operates as a group owner or a group client in new WFD communication. The A 1610 determines whether the link setup is accepted via the link setup response information received from the B 1620. If the link setup is accepted, the A 1610 can transmit link setup confirmation information including information on a determined group owner and a group client to the B 1620 via the group owner 1630 using a method identical to the method of transmitting the link setup request information.

1-2 First STA is in a State of Performing WFD Communication as GO

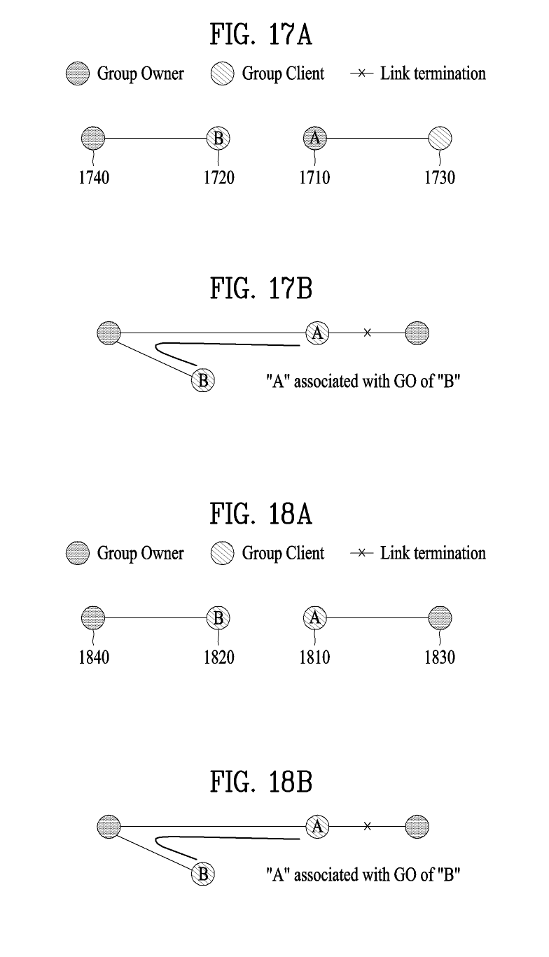

FIG. 17a and FIG. 17b are diagrams for a different embodiment of a method of setting a link using TDLS (tunneled direct link setup) for new WFD communication according to the present invention.

According to the previous embodiment 1-1, a first STA 1710 (hereinafter called A) belongs to no WFD communication group. On the contrary, as shown in FIG. 17a, according to the present embodiment, the A 1710 is communicating with a group client 1730 in a WFD communication group as a group owner.

In a procedure of discovering the B 1720, the A 1710 is able to know that the B 1720 is communicating in the WFD communication as a group client. This is because the aforementioned content is included in discovery response information transmitted to the A 1710 by the B 1720. Hence, the A 1710 can perform TDLS link setup by using a method for the B 1720 to associate with the WFD communication.

If the A 1710 transmits TDLS link setup request information to a group owner 1740 of the B, the group owner 1740 delivers the link setup request information to the B 1720. In this case, the link setup request information can include information indicating that the A 1710 has operated as a group owner for the group client 1730 in a legacy WFD communication group. Having received the link setup request information, the B 1720 determines whether to accept link setup. Having accepted the link setup, the B 1720 transmits link setup response information to the group owner 1740 and the group owner 1740 delivers the received link setup response information to the A 1710. In this case, the link setup response information can include information on whether the B 1720 accepts WFD communication with the A 1710. If the B accepts the link setup with the A 1710 for the WFD communication, the link setup response information can further include information on whether the B operates as a group owner or a group client in new WFD communication. The A 1710 determines whether the link setup is accepted via the link setup response information received from the B 1720. If the link setup is accepted, the A 1710 can transmit link setup confirmation information including information on a determined group owner and a group client to the B 1720 via the group owner 1740 using a method identical to the method of transmitting the link setup request information.

As mentioned in the foregoing description, when the A 1710 is in WFD with the group client 1730, if the A intends to associate with a new WFD communication group, there may exist a problem of whether a legacy WFD communication link is continuously maintained. In particular, there may exist a problem of whether the A 1710 is able to be included in the WFD group of the B 1720 while a connection between the A 1710 and the group client 1730 is continuously maintained. In this situation, although the A 1710 may maintain communication with the legacy group client 1730, it may become a burden for the performance of the A 1710. Hence, it may be preferable to terminate the legacy WFD link to enable the A to concentrate on the new WFD communication.

Timing of terminating the legacy WFD link for the new WFD communication link setup is explained. When the A 1710 discovers the B 1720, in particular, when the A 1710 discovers the B 1720 by receiving discovery response information of the B, the A 1710 terminates the legacy WFD link and may be then able to transmit link setup request information to the group owner 1740 in order not to affect the performance of the A 1710.

1-3 First STA is in a State of Performing WFD Communication as GC

FIG. 18a and FIG. 18b are diagrams for a further different embodiment of a method of setting a link using TDLS (tunneled direct link setup) for new WFD communication according to the present invention.

As shown in FIG. 18a, a first STA 1810 (hereinafter called A) is communicating as a group client in a WFD communication group.

In a procedure of discovering the B 1820, the A 1810 is able to know that the B 1820 is communicating in the WFD communication as a group client. This is because the aforementioned content is included in discovery response information transmitted to the A 1810 by the B 1820. Hence, the A 1810 can perform TDLS link setup by using a method for the B 1820 to associate with the WFD communication.

If the A 1810 transmits TDLS link setup request information to a group owner 1840 of the B, the group owner 1840 delivers the link setup request information to the B 1820. In this case, the link setup request information can include information indicating that the A 1810 has operated as a group client 1830 for a group owner 1830 in a legacy WFD communication group. Having received the link setup request information, the B 1820 determines whether to accept link setup. Having accepted the link setup, the B 1820 transmits link setup response information to the group owner 1840 and the group owner 1740 delivers the received link setup response information to the A 1810. In this case, the link setup response information can include information on whether the B 1820 accepts WFD communication with the A 1810. If the B accepts the link setup with the A 1810 for the WFD communication, the link setup response information can further include information on whether the B operates as a group owner or a group client in new WFD communication. The A 1810 determines whether the link setup is accepted via the link setup response information received from the B 1820. If the link setup is accepted, the A 1810 can transmit link setup confirmation information including information on a determined group owner and a group client to the B 1820 via the group owner 1840 using a method identical to the method of transmitting the link setup request information.

### Embodiment 2

### First STA Performing WFD Communication Invites Second STA to a Group

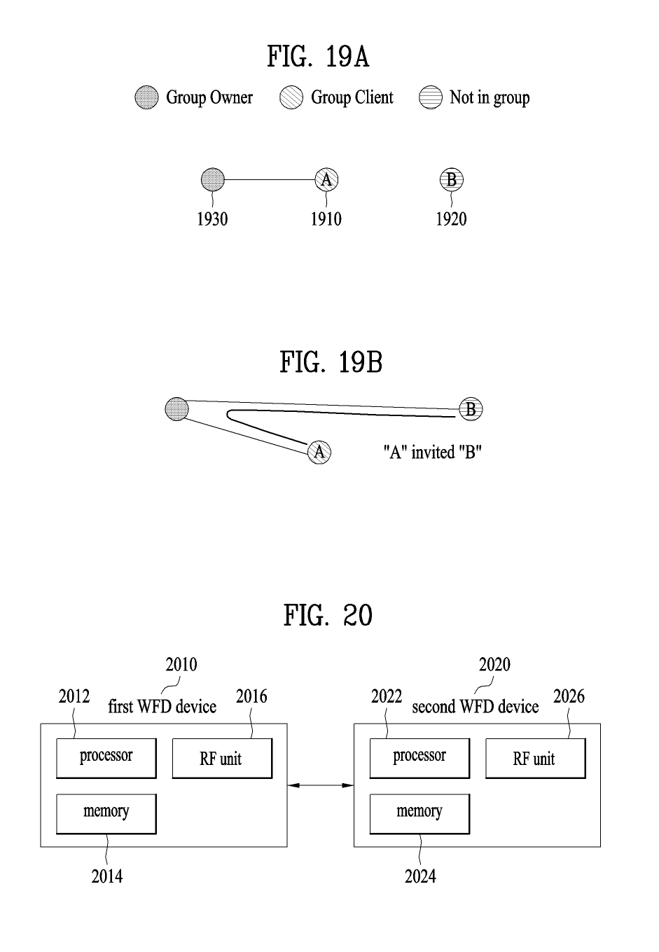

FIG. 19a and FIG. 19b are diagrams for a further different embodiment of a method of setting a link using TDLS (tunneled direct link setup) for new WFD communication according to the present invention.

As shown in FIG. 19a, a first STA 1910 (hereinafter called A) is operating as a group client in legacy WFD communication. If a new WFD connection target, i.e., a second STA 1920 (hereinafter called B) to which a WFD communication link is not set is discovered, the A 1910 is unable to set a direct link to the B 1920. Since there exists only one group owner in a single communication group, the A 1910 may invite the B 1920 to the legacy WFD communication group as a group client since there exists a group owner 1930 in the legacy WFD communication group.

As shown in FIG. 19a, when the A 1910 is operating as a client in the legacy WFD communication group, the TDLS link setup method mentioned earlier in FIG. 13 can be applied. After the A 1910 has discovered the B 1920, a group owner 1930 of the A 1910 plays a role of an AP STA in TDLS link setup in a step of setting a link. In other word, if the A 1910 transmits TDLS link setup request information to the group owner 1930, the group owner 1930 delivers the TDLS link setup request information to the B 1920. In this case, the link setup request information can include information indicating that the A 1910 is operating as a group client in the legacy WFD communication group. Having received the link setup request information, the B 1920 determines whether to accept link setup. Having accepted the link setup request, the B 1920 transmits link setup response information to the group owner 1930. The group owner 1930 delivers the received link setup response information to the A 1910. In this case, the link setup response information can include information on whether the B 1920 accepts WFD communication with the A 1910. If the B accepts the link setup for the WFD communication with the A 1910, the link setup response information can further include information indicating whether the B operates as a group owner or a group client in new WFD communication. The A 1910 determines whether the link setup is accepted via the link setup response information received from the B 1920. If the link setup is accepted, the A 1910 can transmit link setup confirmation information including information on a determined group owner and a group client to the B 1920 via the group owner 1930 using a method identical to the method of transmitting the link setup request information.

FIG. 20 is a diagram for an example of a WFD P2P device to which the present invention is applicable.

Referring to FIG. 20, a WFD network includes a first WFD device 2010 and a second WFD device 2020. The first WFD device 2010 includes a processor 2012, a memory 2014 and a radio frequency (RF) unit 2016. The processor 2012 can be configured to implement a procedure and/or methods proposed by the present invention. The memory 2014 is connected with the processor 2012 and store various information necessary for driving the processor 2012. The RF unit 2016 is connected with the processor 2012 and transmits and/or receives a radio signal. The second WFD device 2020 includes a processor 2022, a memory 2024 and a radio frequency (RF) unit 2026. The processor 2022 can be configured to implement a procedure and/or methods proposed by the present invention. The memory 2024 is connected with the processor 2022 and store various information necessary for driving the processor 2022. The RF unit 2026 is connected with the processor 2022 and transmits and/or receives a radio signal. The first WFD device 2010 and/or the second WFD device 2020 may have a single antenna or multiple antennas.

The above-mentioned embodiments correspond to combinations of elements and features of the present invention in prescribed forms. And, it is able to consider that the respective elements or features are selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

Embodiments of the present invention can be implemented using various means. For instance, embodiments of the present invention can be implemented using hardware, firmware, software and/or any combinations thereof. In the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known in public.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

Although various embodiments according to the present invention are explained centering on IEEE 802.11 system, the embodiments of the present invention can also be applied to various systems capable of performing TDLS-based link setup in an identical scheme.

1. A method of setting a new WFD link, which is set by a first station (STA), with a second STA performing WFD (wireless fidelity direct) communication, comprising the steps of:
transmitting link setup request information, which is transmitted by the first STA, to the second STA via a third STA;
receiving response (setup response) information, which is received by the first STA, from the second STA in response to the link setup request information of the first STA transmitted via the third STA; and
transmitting link setup confirmation information, which is configured based on the response information received by the first STA in response to the link setup request information, to the second STA via the third STA,
wherein the third STA corresponds to a group owner (GO) of the WFD communication of the second STA.

2. The method of claim 1, further comprising the steps of:
transmitting STA discovery request information, which is transmitted by the first STA, to the second STA via an AP of the first STA; and
receiving response (discovery response) information, which is received by the first STA, from the second STA in response to the transmitted STA discovery request information.

3. The method of claim 2, wherein the STA discovery request information corresponds to information transmitted by the AP using one of a unicast method and a broadcast method.

4. The method of claim 2, wherein the response (discovery response) information for the discovery request information comprises information on whether the second STA operates as either a group owner or a group client (GC).

5. The method of claim 1, wherein if the first STA is performing separate WFD communication with the second STA, the first STA terminates the separate WFD communication before making a request for WFD communication link setup set with the second STA.

6. The method of claim 1, wherein the link setup request information comprises at least one of information indicating whether the first STA operates as a GO or a group client (GC) in a legacy WFD communication and a GO intent indicating whether the first STA intends to operate as a GO or a GC in a new WFD communication.

7. The method of claim 1, wherein the response (setup response) information received from the second STA in response to the link setup request comprises a GO intent value indicating whether the second STA intends to operate as either a GO or a group client (GC) in a new WFD communication.

8. The method of claim 6, wherein an STA of which the GO intent value is higher is determined as a GO in the new WFD communication.

9. The method of claim 1, wherein the link setup confirmation information comprises information on whether the first STA and the second STA correspond to a GO or a GC in a new WFD communication based on the response information received from the second STA in response to the link setup request information.

10. The method of claim 1, wherein the link setup confirmation information comprises information on a channel on which the WFD communication is to be performed between the first STA and the second STA.

11. The method of claim 1, wherein an AP of the first STA corresponds to the third STA corresponding to a GO of the WFD communication of the second STA.

12. A method of setting a new WFD link between a first station (STA) performing WFD (wireless fidelity direct) communication and a second STA, comprising the steps of:
transmitting link setup request information, which is transmitted by the first STA, to the second STA via a third STA;
receiving response (setup response) information, which is received by the first STA, from the second STA in response to the link setup request information of the first STA transmitted via the third STA; and
transmitting link setup confirmation information, which is generated based on the response information received by the first STA in response to the link setup request information, to the second STA via the third STA,
wherein the third STA corresponds to a group owner (GO) of the WFD communication of the first STA.

13. A link setup station containing a first STA setting a new WFD link with a second station (STA) performing WFD (wireless fidelity direct) communication, comprising:
an RF (radio frequency) unit configured to communicate with a different terminal;
a memory configured to store information transceived with the different terminal; and
a processor, the processor configured to control the first STA to transmit link setup request information to the second STA via a third STA, the processor configured to control the first STA to receive response (setup response) information from the second STA in response to the link setup request information via the third STA, the processor configured to control the first STA to transmit link setup confirmation information, which is configured based on the response information received in response to the link setup request information, to the second STA via the third STA,
wherein the third STA corresponds to a group owner (GO) of a WFD communication group of the first STA.

14. The link setup station of claim 13, wherein if the first STA performs an operation of discovering the second STA, the first STA transmits STA discovery request information to the second STA via an AP of the first STA and receives response (discovery response) information from the second STA in response to the transmitted STA discovery request information.
